(19) United States
(12) Patent Application Publication
(10) Pub. No.: US 2008/0207389 A1
(43) Pub. Date: Aug. 28, 2008

(54) Drive hub unit for a wind power generator

(76) Inventors: Jurgen Fahrenbach, Aichelberg (DE); Andreas Dangelmayr, Ottenbach (DE); Hans Hofele, Goppingen (DE); Volker Schade, Sussen (DE)

Correspondence Address: RONALD S. LOMBARD;PATENTS AND TRADEMARKS, 4430 TWIN OAKS DRIVE, MURRYSVILLE, PA, 15668, US

(21) Appl. No.: 12/070,170

(22) Filed: Feb. 16, 2008

(30) Foreign Application Priority Data
Feb. 22, 2007 (DE) 10 2007 008 758.8

(51) Int. Cl. F16H 57/08; F16C 21/00; F16C 19/02; F16C 19/00; F03D 9/00

(52) U.S. Cl. 475/344; 384/128; 384/91; 384/445; 290/55

(57) ABSTRACT

A transmission-hub unit (1) for a wind energy installation includes transmission (3) including a single piece rotatably supported transmission part (12, 27) which comprises the input gear wheel (1 1) of the transmission (3) as well as the blade-hub (2). Preferably, only two radial bearings (16, 18) for the support of the blade-hub (2) and the gear wheel (11) are provided. Additionally, axial bearings may be provided. A particularly compact, short, and light-weight arrangement for the transmission (3) and the blade-hub (2) is obtained thereby. The concept is particularly suitable for large wind energy installations.

### CROSS-REFERENCE TO RELATED APPLICATION

The application claims the priority benefits of German Application No. 10 2007 008 758.8 filed Feb. 22, 2007.

### BACKGROUND OF THE INVENTION

The invention resides in a drive hub unit of a wind power generator installation.

Wind power or wind energy installations generally include a rotor with at least one, generally however two or three, rotor blades which are supported so as to be rotatable about a horizontal axis and which drives a generator. Herein, basically two different concepts are pursued. A first concept does not require a transmission. The generator is firmly connected to the rotor for rotation therewith. Another very popular concept resides in the provision of a transmission between the rotor and the generator. The generator is operated at a comparatively high speed whereby it can be smaller and lighter and it requires a relatively small number of poles.

DE 10 2004 036 005 A1, for example, discloses such a concept wherein the rotor drives a central gear which drives several countershafts which represents a power branching. The countershafts drive a common generator via several power transmission paths.

DE 199 17 605 B4 also discloses a transmission for a wind energy installation which is designed to be mounted onto a rotor shaft. The transmission is in the form of a planetary transmission.

Another transmission for a wind power installation is disclosed in DE 101 59 973 A1. This transmission is also designed as an independent unit which is to be coupled to the rotor shaft of a rotor.

Wind energy installations are subject to several restrictions. The rotor shaft must be mounted, for example, in a nacelle disposed at a substantial height on top of a tower. This attempted in this connection to keep the weight of the nacelle and also the use of materials for the nacelle and the components thereof in tolerable limits in spite of increasing sizes of such installations. Furthermore, there are size limits which must be observed. The rotor hub, the transmission, the nacelle and the parts thereof generally cannot exceed certain size limits presented by the open space profiles of the supply roads. Exceedingly, large components could simply not be transported to the assembly location. This is particularly true for land-based installations, but is also a problem for offshore installations.

Finally, wind energy installations are often subjected to large unexpected, that is, stochastic loads which, however, must not lead to damages or fatigues of the installation.

On this basis, it is the object of the present invention to provide an improved concept for the design of a nacelle of a wind energy installations.

### SUMMARY OF THE INVENTION

A transmission-hub unit (1) for a wind energy installation includes a a transmission (3) including a single piece rotatably supported transmission part (12, 27) which comprises the input gear wheel (1 1) of the transmission (3) as well as the blade-hub (2). Preferably, only two radial bearings (16, 18) for the support of the blade-hub (2) and the gear wheel (11) are provided. Additionally, axial bearings may be provided. A particularly compact, short, and light-weight arrangement for the transmission (3) and the blade-hub (2) is obtained thereby. The concept is particularly suitable for large wind energy installations.

The object is solved with the transmission-hub unit according to the invention of a wind energy installation wherein the hub is connected to a rigid transmission part which supports the first gear of the transmission as well as the hub. Basically, the hub and the gear are jointed to form a rigid construction unit, so that the hub support structure and the gear support structure are identical.

With the present invention the conventional concept of providing a separate support for the input gear of the transmission and for the rotor is left behind. With the concept according to the invention, a compact, space-saving arrangement of the hub and transmission is achieved. Specifically, a short unit is obtained, wherein however, the support distance, that is the axial distance between the two radial bearings involved can be maximized. Preferably a flange connection between the hub and the rigid transmission part between the two radial bearings is established. In addition, the gear is arranged preferably also between the two radial bearings or immediately adjacent one of the bearings. One of the two radial bearings is preferably arranged within the hub. In this way, the bearing support distance can be maximized.

Preferably, the transmission part is supported on a tubular carrier. This concept facilitates a minimization of the tilt movements of the transmission part which can have a detrimental effect on the tooth engagement of the gear. Further measures for minimizing the tilt movement may be provided. One of the measures may be for example the provision of one of the bearings in the form of an antifriction bearing, for example, in the form of roller bearing. Preferably both radial bearings are roller bearings. But also friction bearings may be provided which preferably include means for minimizing any play. The gear may be formed integrally with the transmission part, so as to form a single part, for example, by manufacturing it as a single casting. But it is also possible to manufacture the transmission part and the gear separately and join them subsequently, for example, by welding or bolting them together. During operation, however, the gear and the transmission component form a solidly joined structure independently of how they are manufactured.

The gear is in engagement preferably with at least two gears which rotate at higher speed. In a preferred design, the faster rotating gears drive in pairs a generator via additional gears. Preferably, several such gear-generator units are provided so that a load sharing of several high-speed generators is obtained.

Further features of advantageous embodiments of the invention are apparent from the drawings which show exemplary embodiments of the invention.

### BRIEF DESCRIPTION OF THE DRAWINGS

FIG. 1 is a transmission-hub unit in a perspective over-all view;

FIG. 2 is the transmission-hub unit according to FIG. 1 in a longitudinal sectional view;

FIG. 3 is the transmission-hub unit according to FIGS. 1 and 2 in a schematic representation;

FIG. 4 is an alternative embodiment of the transmission-hub unit in a schematic representation;

FIG. 5 is a power transmission scheme for the transmission-hub unit according to FIGS. 1-4 in a schematic representation;

FIG. 6 is a perspective longitudinal-sectional representation a modified embodiment of a transmission-hub unit; and,

FIG. 7 is a compact bearing unit for supporting the hub and the transmission input gear of the transmission hub unit according to FIG. 6 in a perspective representation.

### DETAILED DESCRIPTION OF THE PREFERRED EMBODIMENTS

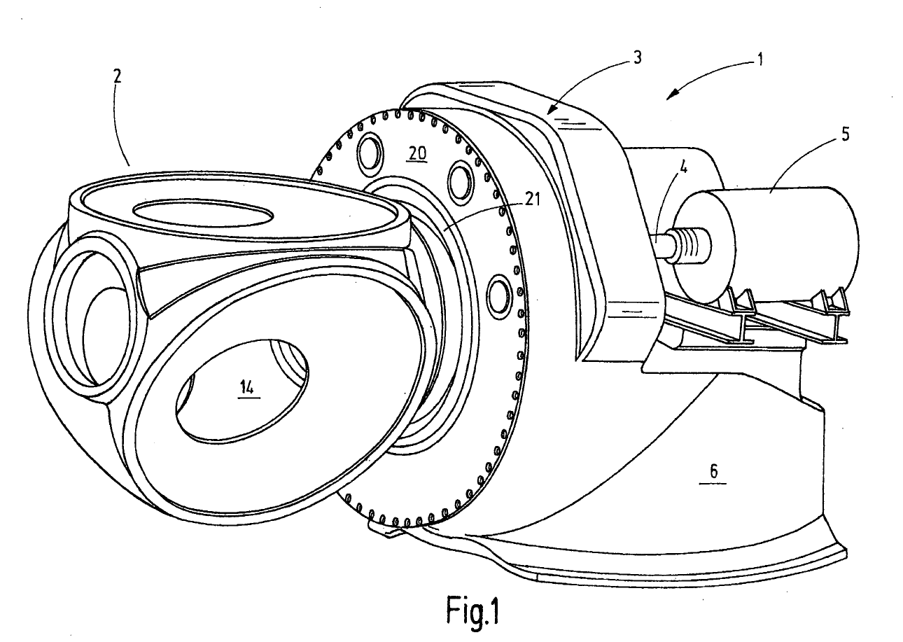

FIG. 1 shows a transmission-hub unit 1 of a wind energy turbine. The transmission-hub unit 1 is mounted in a nacelle, for example, on top of a tower. It carries on its blade-hub 2 which is in the form of a hollow housing several, for example, three rotor blades, not shown, by which the blade-hub 2 is rotated. The rotation of the blade-hub 2 is converted by way of a transmission 3 to a rapid rotation of the drive shaft 4 of at least one electric generator 5. FIG. 1 is not according to scale.

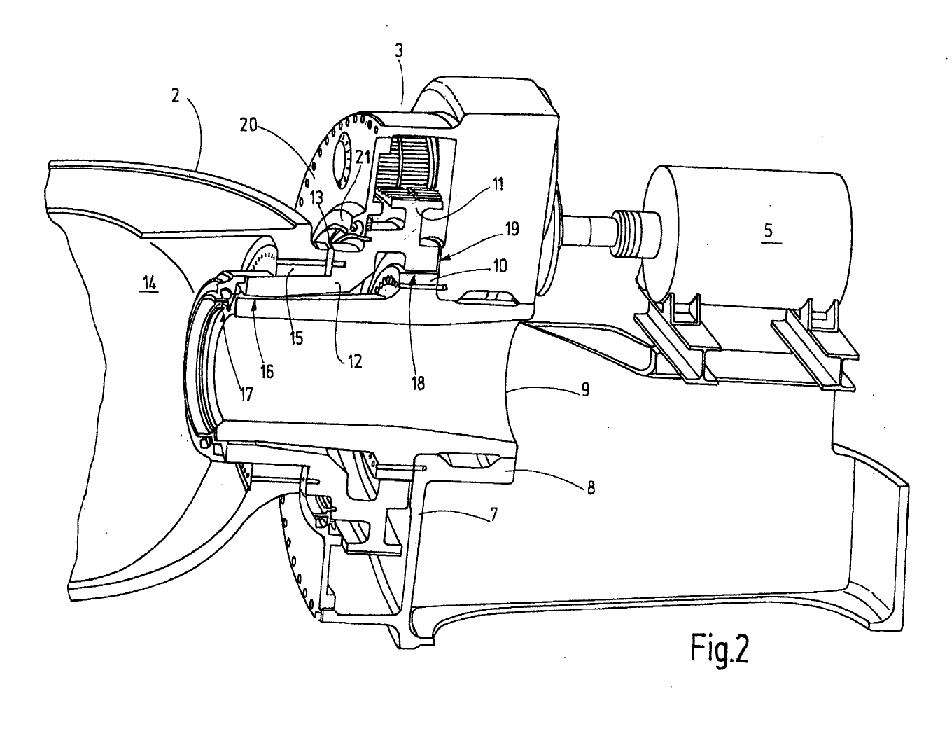

The transmission-hub unit 1 includes a support stand 6 which is part of the nacelle or which is connected thereto. It is supported so as to be rotatable or pivotable about a horizontal axis. The stand 6 is provided with an essentially vertical front wall 7 as shown in FIG. 2 and which forms a support structure for supporting a tubular carrier or sleeve 9. The sleeve 9 is disposed with one end in the essentially cylindrical seal 8 and projects therefrom in a cantilevered fashion supported by the wall 7. The sleeve 9 is provided with a radial flange 10, which is bolted to the wall 7 in the area of the seat 8.

The sleeve 9 includes a central opening via which various elements extend to the blade-hub 2. These elements are, for example, shafts, rods or conduits for the mechanical, pneumatic, hydraulic or electric rotor blade adjustment.

The sleeve 9 serves as bearing support for the blade-hub 2 and also the gear 11 which is part of the transmission 3. The gear 11 forms the input gear for the transmission 3. In the present embodiment, it is an integral part of the transmission part 12, which is rotatably supported on the sleeve 9. The transmission part 12 includes an outer circumference, a shoulder 13 arranged at a distance from the front end of the blade-hub 2, where the blade-hub 2 is bolted to the transmission part 12. To this end, the blade-hub 2 includes a corresponding flange with mounting bores. The blade-hub 2 is consequently disposed on the outer circumference of the transmission part 12.

The transmission part 12 extends, like the sleeve 9, into the inner space 14 enclosed by the blade-hub 2. At its front end, that is preferably ahead of the mounting flange 15, a radial bearing 16 is formed between the end of the transmission part 12 disposed within the blade-hub 2 and the respective end of the sleeve 9. This radial bearing may be a friction bearing. Preferably, however, it is a roller bearing. At the front end of the sleeve 9 and of the transmission part 12, a seal arrangement 17 with several stationary and rotating seal rings forming a labyrinth seal is arranged in order to collect oil or other lubricant escaping from the radial bearing 16 and return it to the lubricating circuit.

As mentioned earlier, the transmission part 12 includes the gear wheel 11. In the preferred embodiment, the transmission part 12 and the gear wheel 11 are an integrally formed casting component. However, the component may be formed from two or more parts which are welded or bolted together. The gear wheel 11 is preferably a spur gear with double helical gear structure, i.e., herringbone gearing. Such a gearing causes an automatic centering of the gears in engagement with each other. In principle, however, also a straight gearing as shown in FIG. 2 may be used. Other types of gearings, such as involute gearing or cycloid gearing may also be used. An involute gearing is preferred if a relatively large bearing, say as expected for the transmission part 12.

The support arrangement for the transmission part 12 includes a second radial bearing 18 which, in the present embodiment is arranged immediately adjacent the gear wheel 11. That is, the second radial bearing 18 which supports the blade-hub 2 is disposed within the transmission 3. Also, the radial bearing 18 can be in the form of a friction bearing but, preferably, is a roller bearing.

The support arrangement may further include one or several axial pressure bearings, such as for example, the axial bearing 19 which is arranged adjacent the radial bearing 18. The axial bearing 18 is also arranged within the transmission 3 and is designed to accommodate axial faces. It can be a friction bearing or an anti-friction bearing. A second axial bearing which is not shown may be arranged, for example, at the front end of the transmission part 12 near the radial bearing 16 or at another location suitable for accommodating axial forces. The axial forces of the axial bearings are directed opposite to the axial forces accommodated by the axial bearing 19.

At its front end next to the hub 12, the transmission 3 is closed by a front wall 20. The front wall 20 has a central opening through which the transmission part 12 extends. For sealing and for collecting lubricant or oil seeping out of the transmission 3, the front wall 20 is provided with a seal arrangement 21 which is preferably in the form of a labyrinth seal.

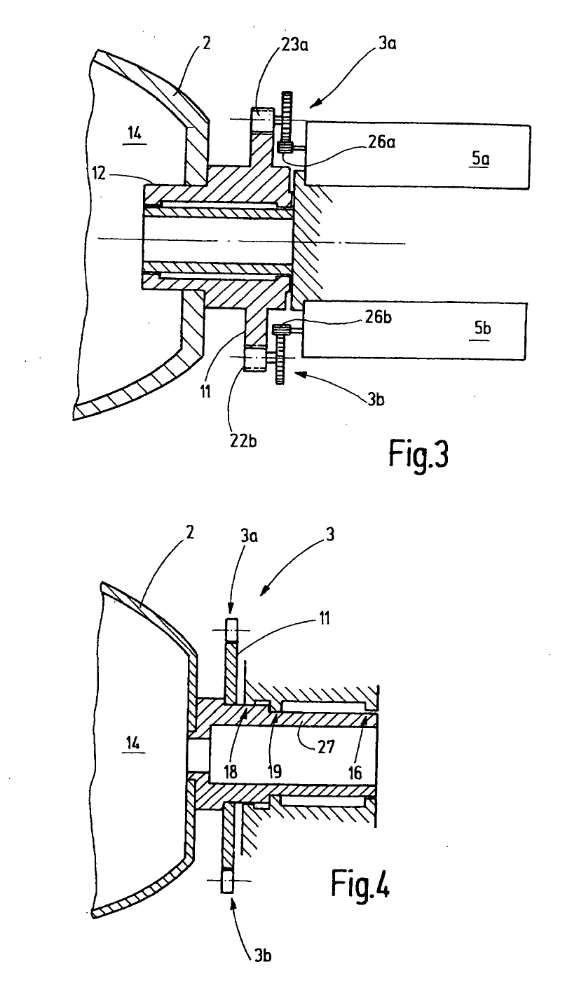

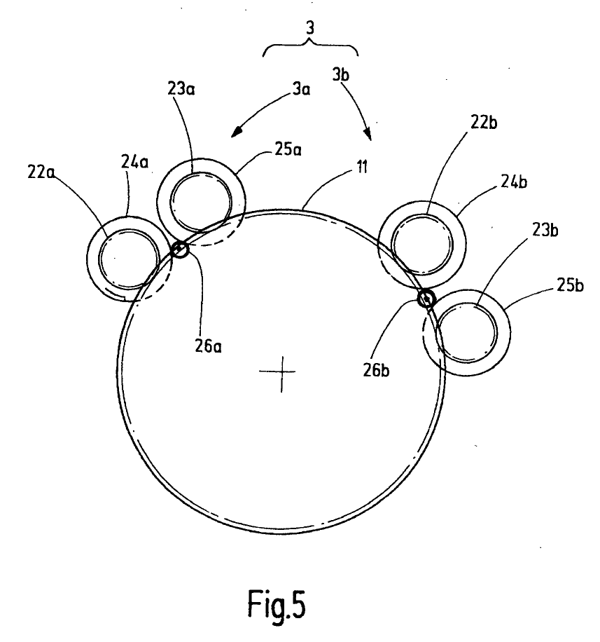

The FIGS. 3 and 5 show more clearly the functionality of the support arrangement and of the transmission 3. As shown for each of the generators 5a, 5b, a partial transmission structure or drive 3a, 3b is provided whereby the rotation of the gear wheel 11 is transmitted to a faster speed. The drives 3a, 3b are preferably of the same design and are arranged at different locations of the circumference of the gear wheel 11. In the shown embodiment, two partial transmissions or drives 3a, 3b are provided. However, there may be more such drives. In the embodiment shown, the two drives 3a, 3b are arranged spaced by an angle of 180° in order to apply to the radial bearings 16, 18 a more balanced load.

The drive 3a includes two gears 22a and 23a, see FIG. 5. They are rotatably supported with their axes extending parallel to the axis of rotation of the transmission part 12. By way of respective counter-shafts with gears 24a, 25a, which are in engagement with the pinion 26a, the gears 22a and 23a drive the gears 24a and 25a. The pinion 26a drives the generator 5a.

The same description applies to the drive 3b wherein only the letter index a is to be replaced by the letter index b.

The following description refers to gears and generators without letter indexes and is intended to be applicable equally to both drives 3a, 3b.

The gears 24, 25 preferably have another tooth pitch than the gear wheel 11. In addition, another gearing type may be selected. For example, the gears 24, 25, 26 may have helical gearing or straight fluted gearing. It may also be expedient to select a cycloid gearing, whereas the gears 11, 22, 23 have involute teeth.

The transmission-hub unit 1 described above operates as follows:

During operation, the rotor blades, not shown, supported on the blade-hub 2 rotate the blade-hub 2 at a relatively low speed of, for example, 0.5 revolutions per second. The wind load effective on the rotor blades and the blade-hub 2 is accommodated as an axial load by the axial bearing 19. Weight forces and other loads are carried by the radial bearings 16, 18. If wind gusts are effective, for example, only on one side of the blade-hub 2 additional radial loads occur. They are relatively easily accommodated by the relative large support distance between the radial bearings 16, 18 and result only in little eccentricity of the gear wheel 11. This is particularly true if the radial bearing 16 is arranged “ahead” of the blade-hub 2 that is within the interior space 14 and the radial bearing 18 is arranged “behind” the gear wheel 11. In any case, the gear wheel 11 and the blade-hub 2 are rigidly coupled. Possible small eccentricities of the gear wheel 11 as a result of dynamic wind loads are tolerated by the gearing of the gear wheel 11 and the gears 22, 23 in engagement therewith.

The gears 24, 25 are rigidly coupled to the gears 22, 23 and drive the generator 5 via the pinion 26. Preferably, the generator operates at a high speed of, for example, 1000 revolutions per minute or more.

FIG. 4 shows a modified embodiment, wherein the blade-hub 2 is connected to a hollow shaft 27, which carries the gear wheel 11 and thus corresponds to the transmission part 12 of the earlier described embodiment. The blade-hub 2 and the gear wheel 11 are again rigidly joined. A first radial bearing 18 is arranged within or next to the gear wheel 16. The second radial bearing 16 is arranged at a relatively large distance from the radial bearing 18 at the rear end of the hollow shaft 27. It is consequently arranged within a space or circle surrounded by the generators 5. With respect to the transmission 3 or the partial drives 3a, 3b, thereof, the earlier description also applies here.

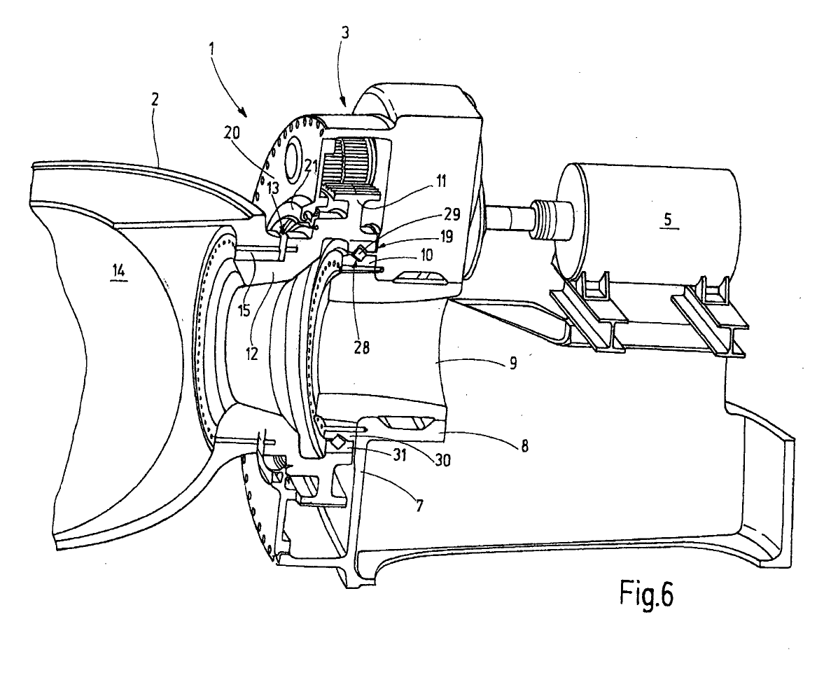

FIG. 6 shows a modified embodiment of the transmission-hub unit described above. Herein, the transmission part 12, which is rigidly connected to the blade-hub 2 and supports the blade-hub 2 and which at the same time forms or carries the gear wheel 11, is supported by a compact bearing unit 28. Preferably the compact bearing unit 28 is the only bearing arrangement supporting the transmission part 12. It provides for axial as well as radial support. Separate axial and radial bearings are preferably not provided. The compact bearing unit 28 is preferably provided immediately adjacent the gear wheel 11. As shown in FIG. 6, it may be disposed in a space surrounded by the gear wheel 11. Alternatively, the compact bearing unit 28 may also be arranged between the gear wheel 11 and the shoulder 13 which forms the mounting seal for the blade-hub 2. If necessary, the compact bearing unit 28 may also be arranged within the blade-hub 2. Alternatively, the compact bearing unit 28 may be displaced toward the generators, that is, in FIG. 6 to the right of the gear wheel 11. However, the arrangement as shown in FIG. 6 is preferred.

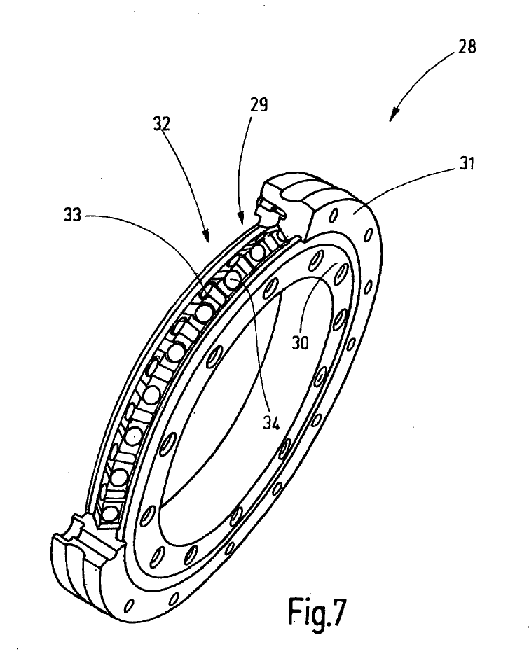

FIG. 7 shows schematically the compact bearing unit 28 which is preferably in the form of a cross-roller bearing. The cross-roller bearing includes an inner ring 30 and an outer ring 31. As shown in the figure those may be individual parts. However, the inner ring 30 may be part of the sleeve 9. It is also possible that the outer ring 31 is formed as part of the transmission part 12.

Between the inner ring 30 and the outer ring 31, rolling bodies 32 are arranged. These are preferably cylindrical rollers, conical rollers, barrel-shaped rollers 33, 34 or similarly formed rollers. The rollers are alternately sorted in two groups. The rollers 33 of the first group roll along an inner and an outer track arranged at an angle of essentially 900 with respect to a second pair of tracks along which the rollers 34 of the second group are rolling. The axes of rotation of the rollers 33 are disposed on a cone which opens in a first axial direction. The axes of rotation of the rollers 34 of the second group are disposed on a cone which opens in the opposite axial direction. The cross-roller bearing 29 supports the transmission part 12 and consequently also the gear wheel 11 as well as the blade-hub 2 in axial direction and also in the radial direction. Preferably the roller bearing 29 is pre-biased so that it operates without any play.

A transmission hub unit 1 according to the invention for a wind energy installation includes a rotatably supported single piece transmission part 12, 27, which carries the input gear wheel 11 of the transmission 3 as well as the blade-hub 2. Preferably, only two radial bearings 16, 18 are provided for supporting the hub 12 and the gear wheel 11. Additionally, axial bearings may be provided. A particularly compact, short and light-weight design for the transmission 3 and blade-hub 2 is obtained thereby. The concept is particularly suitable for large wind energy installations.

What is claimed is:

1. Transmission-hub unit (1) of a wind energy installation comprising:
a blade-hub (2) supporting at least one rotor blade; and,
transmission (3) including a rigid transmission part (12, 27) firmly connected to the blade-hub (2), said transmission part (12, 27) includes a gear wheel (11) rotatably supported by at least one bearing (16, 18, 28) serving as bearings structures for the gear wheel (11) as well as the blade-hub (2).

2. Transmission-hub unit according to claim 1, wherein at least one of the bearings (16, 18, 28) is arranged in the vicinity of the gear wheel (11).

3. Transmission-hub unit according to claim 1, wherein at least one of the bearings (16, 18, 28) is arranged, viewed from the blade-hub (2), at or behind the gear wheel (11).

4. Transmission-hub unit according to claim 1, wherein at least one bearing (28) is a cross-roller bearing.

5. Transmission-hub unit according to claim 1, wherein at least one of the bearings (11, 28) is arranged, viewed from the blade-hub (2) at or in front of the gear wheel (11).

6. Transmission-hub unit according to claim 1, wherein at least one of the bearings (16, 18) is arranged within the blade-hub (2).

7. Transmission-hub unit according to claim 1, wherein at least one of the bearings (16, 18) is supported on a tubular carrier (9).

8. Transmission-hub unit according to claim 1, wherein the tubular carrier (9) comprises an opening leading to the blade-hub (2).

9. Transmission-hub unit according to claim 1, wherein the blade-hub (2) is firmly bolted to the rigid transmission part (12, 27).

10. Transmission-hub unit according to claim 1, wherein the transmission part (12, 27) is formed integrally as a single body with the gear wheel (11).

11. Transmission-hub unit according to claim 1, wherein the transmission part (12, 27) is firmly connected to the gear wheel (11).

12. Transmission-hub unit according to claim 1, wherein the transmission part (12, 27) is bolted to the gear wheel (11).

13. Transmission-hub unit according to claim 1, wherein the transmission (3) further includes at least two spur gears (22, 32) spaced from each other and the gear wheel (11) is a spur gear which is engaged with said at least two spur gears (22, 23).

14. Transmission-hub unit according to claim 13, further including at least two generators (5a, 5b), said at least two generators (5a, 5b) are driven by the gear wheel (11).

15. Transmission-hub unit according to claim 14, wherein said two spur gears (22a, 23a) in engagement with the gear wheel (11) are drivingly connected to a common generator (5a).

16. Transmission-hub unit according to claim 1, wherein the bearings comprise at least two radial bearings (16,18) and at least one axial bearing (19).

17. Transmission-hub unit according to claim 1, wherein at least one of the bearings (16, 18, 19) is a roller bearing.

18. Transmission-hub unit according to claim 1, wherein at least one of the bearings (16, 18, 19) is a friction bearing.
